(19) United States
(12) Patent Application Publication
(10) Pub. No.: US 2022/0036440 A1
(43) Pub. Date: Feb. 3, 2022

(54) POINT OF SALE SYSTEM AND METHOD FOR VISUALIZING AND TRANSACTING ON REAL ESTATE SPACES AND THE PRODUCTS WITHIN THESE SPACES

(71) Applicant: CITY LINE 360 LLC, New Rochelle, NY (US)

(72) Inventor: Ryan Jaeger, New Rochelle, NY (US)

(73) Assignee: CITY LINE 360 LLC, New Rochelle, NY (US)

(21) Appl. No.: 17/155,024

(22) Filed: Jan. 21, 2021

Related U.S. Application Data
(60) Provisional application No. 63/058,996, filed on Jul. 30, 2020.

(51) Int. Cl. G06Q 30/06; G06Q 50/16; G06Q 20/20; G06Q 20/12; G06F 30/13; G06F 30/12; G06F 16/54; G06F 16/538; G06F 16/29; G06F 16/587; G06F 3/0481; G06F 3/0482

(52) U.S. Cl. CPC G06Q 30/0643; G06Q 50/16; G06Q 20/20; G06Q 30/0625; G06Q 30/0633; G06Q 20/12; G06F 3/0482; G06F 30/12; G06F 16/54; G06F 16/538; G06F 16/29; G06F 16/587; G06F 3/04815; G06F 30/13

(57) ABSTRACT

Embodiments of the present invention provide for a method and system for point of sale (POS) real estate transactions. The exemplary system includes a database of interactive three-dimensional (3D) floorplans of real estate property and a database of 3D interactive digital replicas of furniture, fixtures, and equipment (FFE) used in real estate. Further, the exemplary system includes an interactive virtual reality digital space within which to manipulate the 3D interactive floorplans as well as insert the 3D digital replicas of the FFE to create a customized virtual real estate space. Further, the exemplary system also includes an electronic checkout mechanism so that the user can purchase the real-world versions of the real estate property and FFE in the customized virtual real estate space.

### CROSS-REFERENCE TO RELATED APPLICATION

This application claims the benefit of U.S. Provisional Patent Application No. 63/058,996, which was filed on Jul. 30, 2020 and is incorporated by reference in its entirety.

### FIELD OF THE INVENTION

The present disclosure relates to a point of sale (POS) system associated with supply chain management and interior design using digital visualization. More specifically, as they apply to products that compliment commercial and residential real estate.

### BACKGROUND OF THE INVENTION

Existing online, residential real estate transactions take place on separate platforms than home-goods transactions. However, the standard residential real estate purchase comes unfurnished. As a result, residential brokers must often pay to stages spaces. Additionally, many tenants purchase furnishings in-store and online that are later returned because they do not fit in the space with respect to size or style. Further, the cost of price per square foot products and services such as paint, flooring, and other installations are difficult for buyers to visualize. Finally, the accumulation of several independent or related transactions warrants a budgeting system to assist buyers.

As such, it would be desirable to have systems and methods that could overcome these and other deficiencies of known systems. In particular, a need exists for a tool capable of reducing real estate staging needs, reducing returns on purchased real estate related goods, providing immediate cost estimates for services based on real estate size and shape, digitally visualizing furnishings to make more appropriate purchases regarding size, shape, and style, and helping online buyers better understand the true cost of occupying a residential and/or commercial space.

### SUMMARY OF THE INVENTION

Embodiments of the present invention relate to point of sale (POS) system associated with supply chain management and interior design using digital visualization.

According to an embodiment, the present invention relates to a software computer program comprising an interactive three-dimensional (3D) POS system for visualizing real estate spaces and furniture, fixtures, and equipment (FFE), which can be dragged, placed, and manipulated within said 3D space. This visualization component can provide users with the ability to orbit, navigate, and explore the 3D space with ease whilst manipulating it and customizing it with FFE. For example, adjustments can be made to rotate and move items along several axes. Further, after the desired FFE is selected, the exemplary software computer program enables a user to transact on both, hence establishing this invention as a wholistic e-commerce tool.

According to an embodiment, the 3D space can be developed based on two-dimensional (2D) floor plans. For example, a model of the desired real estate space can be designed and built via a computer-aided design program based on the 2D floor plans. This model can then be downloaded into an exemplary 3D game engine, e.g., a physics-based game engine. In this regard, using the 3D game engine, objects can be portrayed with reflective lighting or can be given a mass that will conform to the law of gravity. According to another embodiment, an image of the desired real estate space can be captured with a 3D scanning and imaging tool (e.g., Artec 3D scanner), with the scanned image being directly downloaded into the 3D game engine. According to an embodiment, the digital replicas/renditions of the FFE can also be created based on either of the above-described processes.

According to an embodiment, the present invention further comprises a first database including real-time, dynamic information pertaining to FFE and other products as well as their corresponding digital replicas. In particular, the first database can store quantitative and qualitative product data as well as a 3D file corresponding to the digital replica of the product. Further, according to an embodiment, the present invention can comprise a second database including real-time, dynamic information pertaining to available real estate spaces (e.g., for rent/sale) and their corresponding digital replicas. In particular, the second database can store quantitative and qualitative real estate data as well as a 3D file corresponding to the digital replica of the real estate space.

According to an embodiment, a point of sale system for virtually visualizing a real estate space and at least one object to be used within the real estate space can include: a first database including a first interactive 3D digital rendition of the real estate space; a second database including a second interactive 3D digital rendition of the at least one object; a third database including cost information associated with at least one of the real estate space and the at least one object; and a computer-implemented graphical user interface (GUI), wherein the computer-implemented GUI is configured to: (i) retrieve, in real time, the first interactive 3D digital rendition of the real estate space from the first database upon a selection of the real estate space with the GUI; (ii) retrieve, in real time, the second interactive 3D digital rendition of the at least one object from the second database upon a selection of the at least one object with the GUI; (iii) retrieve, in real time, the cost information from the third database upon the selection of at least one of the real estate space and the at least one object with the GUI; and (iv) display the first interactive 3D digital rendition of the real estate space, the second interactive 3D digital rendition of the at least one object, and the cost information associated with the at least one of the real estate space and the at least one object, wherein the second interactive 3D digital rendition of the at least one object is movable within the first interactive 3D digital rendition of the real estate space.

According to an embodiment, point of sale method for virtually visualizing a real estate space and at least one object to be used within the real estate space can include: (i) upon a selection of the real estate space with a GUI, retrieving, with the computer-implemented graphical user interface GUI, in real time, a first interactive three-dimensional (3D) digital rendition of the real estate space from a first database; (ii) upon a selection of the at least one object with the computer-implemented GUI, retrieving, with the computer-implemented GUI, in real time, a second interactive 3D digital rendition of the at least one object from a second database; (iii) upon a selection of at least one of real estate space and the at least one object with the computer-implemented GUI, retrieving, with the computer-implemented GUI, in real time, cost information associated with at least one of the real estate space and the at least one object from a third database; and (iv) displaying, with the computer-implemented GUI, the first interactive 3D digital rendition of the real estate space, the second interactive 3D digital rendition of the at least one object, and the cost information associated with the at least one of the real estate space and the at least one object, wherein the second interactive 3D digital rendition of the at least one object is movable within the first interactive 3D digital rendition of the real estate space.

In this regard, unlike current systems and methods, with the present invention, a single graphical user interface can be used to (i) select a real estate space to digitally render (in 3D), (ii) select FFE to digitally render in the 3D digital rendition of the real estate space, (iii) retrieve and display cost information associated with the selected real estate space and the selected FFE, and (iv) execute a purchase transaction of the real estate space and the FFE. In addition, the present invention also provides for (i) the selection and digital rendition of FFE by multiple users, (ii) the tracking of the FFE selected by the multiple users based on each user's Internet Protocol (IP) address, and (iii) the execution of a purchase transaction among the multiple users based on the respective IP addresses.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of embodiments of the disclosure. In this regard, the description, taken with the drawings, makes apparent to those skilled in the art how aspects of the disclosure may be practiced.

FIG. 1 depicts a block diagram of a system according to an exemplary embodiment of the invention.

FIG. 2 depicts a block diagram of the system of FIG. 1 according to another exemplary embodiment of the invention.

FIG. 3 depicts a screenshot of a graphical user interface according to an exemplary embodiment of the invention.

FIG. 4A depicts a screenshot of the graphical user interface in FIG. 3 according to another exemplary embodiment of the invention.

FIG. 4B depicts a screenshot of the graphical user interface in FIG. 3 according to another exemplary embodiment of the invention.

FIG. 4C depicts a method according to an exemplary embodiment of the invention.

FIG. 5A depicts a screenshot of a graphical user interface according to an exemplary embodiment of the invention.

FIG. 5B depicts a screenshot of the graphical user interface in FIG. 5A according to another exemplary embodiment of the invention.

FIG. 6A depicts a screenshot of a graphical user interface according to an exemplary embodiment of the invention.

FIG. 6B depicts a screenshot of the graphical user interface in FIG. 6A according to another exemplary embodiment of the invention.

FIG. 6C depicts a screenshot of the graphical user interface in FIG. 6A according to another exemplary embodiment of the invention.

FIG. 6D depicts a screenshot of the graphical user interface in FIG. 6A according to another exemplary embodiment of the invention.

FIG. 6E depicts a screenshot of the graphical user interface in FIG. 6A according to another exemplary embodiment of the invention.

FIG. 6F depicts a screenshot of the graphical user interface in FIG. 6A according to another exemplary embodiment of the invention.

### DETAILED DESCRIPTION

This description is not intended to be a detailed catalog of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to affect a disavowal of any part of the full scope of the invention. Hence, the following descriptions are intended to illustrate some particular embodiments of the disclosure, and not to exhaustively specify all permutations, combinations and variations thereof.

Unless explicitly stated otherwise, the definition of any term herein is solely for identification and the reader's convenience; no such definition shall be taken to mean that any term is being given any meaning other than that commonly understood by one of ordinary skill in the art to which this disclosure belongs, unless the definition herein cannot reasonably be reconciled with that meaning. Further, in the absence of such explicit definition, all technical and scientific terms used herein have the same meaning as commonly understood by one of ordinary skill in the art to which this disclosure belongs. The terminology used in the description of the disclosure herein is for the purpose of describing particular embodiments only and is not intended to be limiting of the disclosure.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

As used in the description of the disclosure and the appended claims, the singular forms “a”, “an”, and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

As noted above, the exemplary system of the present invention allows for a potential customer, prospective renter, or purchaser of a real estate space to select a floorplan of one of an apartment/condominium, house, factory, commercial space, office space, etc., and furnish it with desired furniture, fixtures, and equipment before touring it. It also allows users to virtually decorate and paint the real estate space. Further, the system allows the users to virtually walk around the designed space as if they were there in person. Once the user(s) determine they like it, they can rent/purchase the space and have the selected furnishings delivered and other steps to be taken for them to move into the real estate space.

The system can have qualitative and quantitative information, including cost, regarding the available real estate spaces provided by landlords, developers, contractors, etc. The system will also include vendors of FFE items and the specific qualitative and quantitative information concerning their products, including cost of the various furnishings as well as type (e.g., couch), its dimensions, material, design, fabric covering, color, rating, etc. Further, the user, as they progress through the processes of designing and furnishing the virtual real estate space, will be provided with a running account of the itemized cost as well as the total cost. As such, the system of the present invention can allow a user to rent/purchase an apartment, condo, or house, have it decorated and furnished in the fashion they desire, pay for it and then move in without even physically touring the property in person prior to moving into the real estate space.

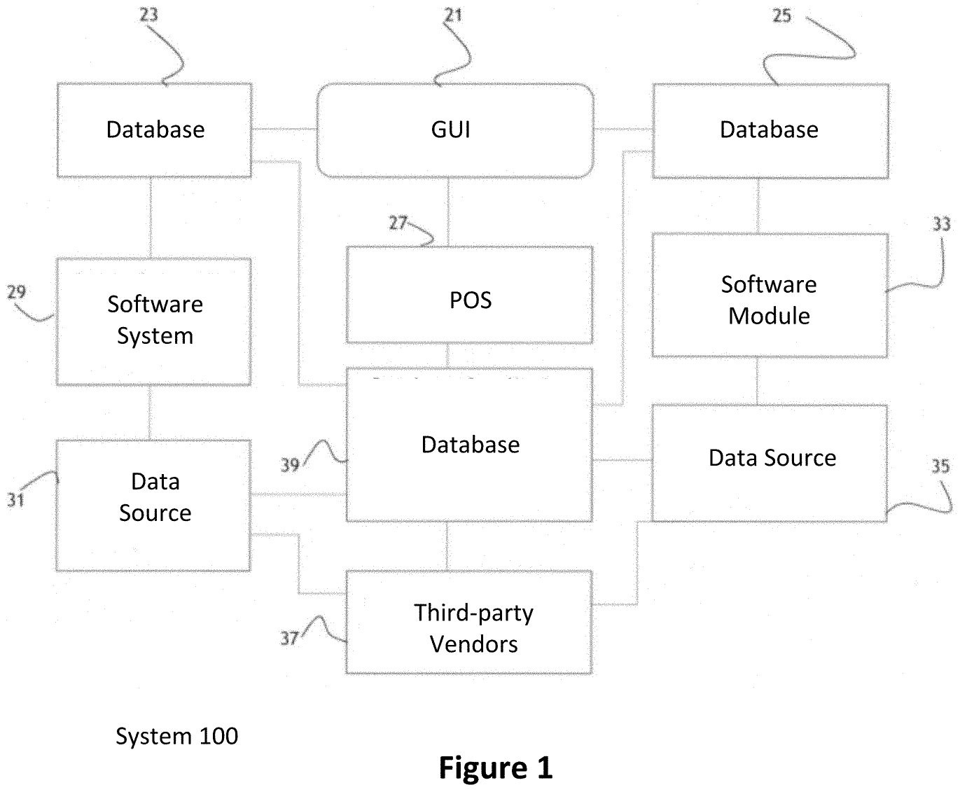

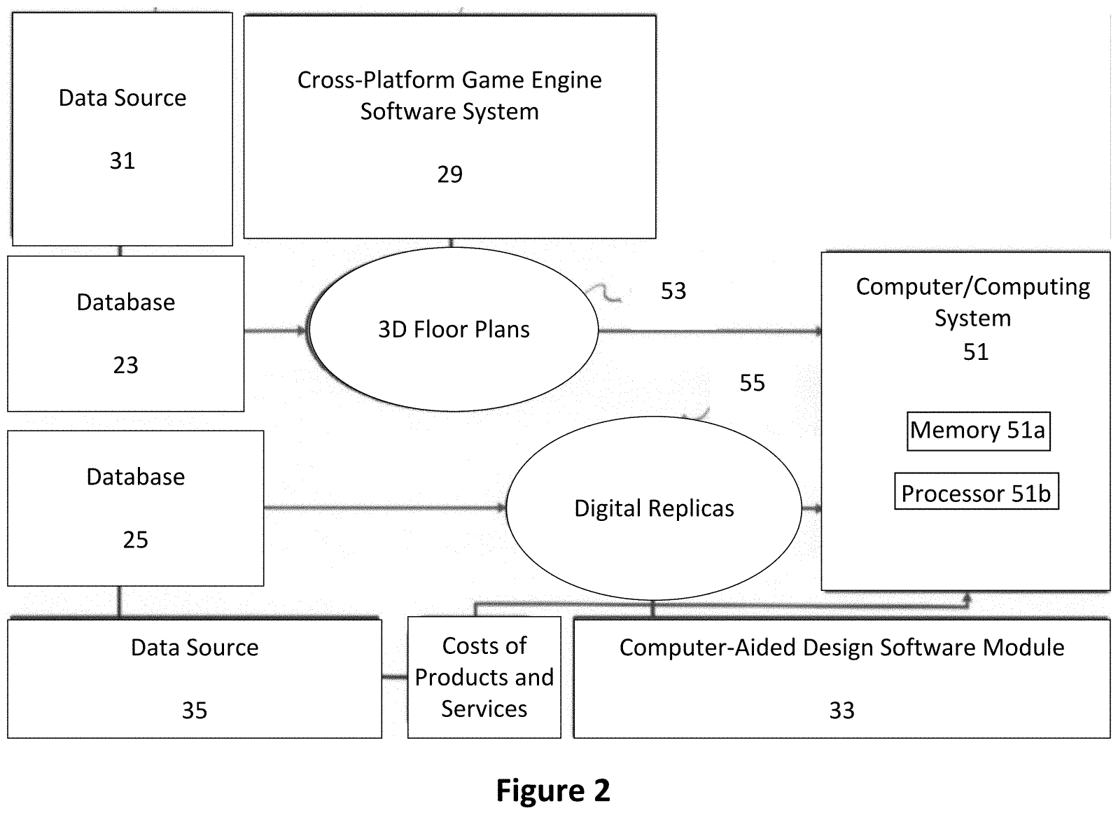

FIG. 1 depicts a block diagram of a system according to an exemplary embodiment of the invention. A system 100 can include an interactive virtual reality 3D graphical user interface (GUI) 21, which can be provided on a computer(s)/computing system 51, which is depicted in FIG. 2. The computer(s)/computing system 51 can be one of a personal computer, a kiosk, a tablet, a mobile device, smart watch, etc. According to an embodiment, the GUI 21 can be displayed on a display associated with the computer. According to an embodiment, the display can be a liquid crystal display (LCD), e.g., thin-film-transistor (TFT) LCD, in-place switching (IPS) LCD, capacitive or resistive touchscreen LCD, etc. Further, the display can also be an organic light emitting diode (OLED), e.g., active-matrix organic light emitting diode (AMOLED), super AMOLED, etc.

According to an embodiment, the GUI 21 can dynamically connect to a database 23 of 3D interactive renditions of real estate spaces, a database 25 of digital replicas for various items of furniture, fixtures, and equipment (FFE) that would be used in the interactive 3D real estate spaces, and an integrating point of sale (POS) software module 27.

According to an embodiment, the database 23 can connect to a game engine software system 29 for creating 3D renditions of interactive real estate spaces, which in turn connects to a data source 31 of 2-dimentional (2D) floor plans, house or structure plans or actual real estate spaces that the software module 29 turns into interactive 3D renditions of the 2D floor plans or videos of existing real estate spaces. Actual real estate spaces being existing houses or other similar real estate spaces for sale or rent. According to another embodiment, the data source 31 of 2D floor plans could be replaced by a source of 3D scanned real estate spaces. In this regard, the 3D scanned real estate spaces can be captured with a 3D scanning and imaging tool, e.g., Artec 3D scanner, LIDAR scanning applications on mobile devices (e.g., CANVAS). According to an embodiment, the number of required scans of the real estate space can depend on the surface area of the real estate space. For example, 4 or 5 scans can be required to fully acquire all of the datapoints of a standard 750 square foot apartment. Further, according to an embodiment, the scans be downloaded as a zip file, where the unzipped package can result in two format types: .obj files and the .jpg files. In this regard, the .obj files can represent the structure of the 3D file, while the .jpg file can represent the textures (e.g., colors) associated with the real estate space. Accordingly, the .obj and .jpg files can be uploaded to the game engine software system 29, which then applies the uploaded structures and textures to their corresponding locations in the 3D file.

According to an embodiment, the GUI 21 can connect to the database 23 periodically. For example, the GUI 21 can connect to the database 23 one or more times a day at a time(s). According to another embodiment, the GUI 21 can connect to the database 23 only after there is a change at the database 23, e.g., addition and/or removal of the 3D renditions of interactive real estate spaces. Further, according to another embodiment, the GUI 21 can connect to the database 23 after a user selection of a particular 2D floor plan for conversion to 3D. According to an embodiment, the 2D floor plan can be associated with a 2D .dwg file format.

The database 25 can connect to a computer-aided design software module 33 for creating digital replicas, which in turn connects to a data source 35 of items to be rendered into digital replicas. Such items to be rendered into digital replicas being various FFE. Third-party vendors 37 of home and office products provide the data source 35 of the items to be included in floor plans, real estate spaces, etc. According to another embodiment, the software module 33 can be compatible with a Unity-based development platform. According to an embodiment, the GUI 21 can connect to the database 25 periodically. For example, the GUI 21 can connect to the database 25 one or more times a day at a time(s). According to another embodiment, the GUI 21 can connect to the database 25 only after there is a change at the database 25, e.g., addition and/or removal of the digital replicas. Further, according to another embodiment, the GUI 21 can connect to the database 25 after a user selection of a particular object for conversion to 3D. According to an embodiment, the particular object can be selected by clicking one of general web text and/or a photo associated with the object. In this regard, the general web text and/or photos can be associated with a .htm or .html file. Further, once selected, the converted object can be associated with at least one of an .obj file format, a .jpg file format, a .fdx file format, and a .stl file format.

According to an embodiment, the integrating POS module software 27 can provide a running account of the itemized cost of FFE selected and included as digital replicas within the selected real estate space as the user designs and furnishes the virtual space. In this regard, a database 39 can include qualitative and quantitative information (e.g., cost, type, dimensions, material, design, fabric covering, color, rating, etc.) on the items and real estate spaces in databases 23 and 25. Accordingly, the integrating POS module 27 can retrieve any necessary information, e.g., cost information for the desired real estate space and FFE items, from the database 39. In this regard, data in the database 39 can be input by, for example, real estate property owners, landlords, and/or brokers. According to an embodiment, the database 39 can also be structured using back-end administrative accounts. the accounts can require confirmation that the POS module 27 has the permission of the property owner to close a deal (and therefore terminate the property's status as an available listing) if the user's inputs (including datapoints not limited to monthly rent, purchase price, lease length, credit score, as well as any other criteria required by the property owner) are met.

Further, according to an embodiment, the POS module 27 can also arrange times for when the user can acquire access to the property from the landlord or previous owner. In this regard, the POS module 27 can consider additional costs such as tax, security deposits, and furnishing costs (based on furnishing selections of the user, among other costs). Further, according to another embodiment, the POS module 27 can also act as a record for the legal change of title of properties.

Further, according to an embodiment, the GUI 21 can connect to the database 39 periodically. For example, the GUI 21 can connect to the database 39 one or more times a day at a time(s). According to another embodiment, the GUI 21 can connect to the database 39 only after there is a change at the database 25, e.g., addition and/or removal of cost and/or other information. Further, according to another embodiment, the GUI 21 can connect to the database 25 after a user selection of a particular 2D floor plan and object for conversion to 3D.

According to an embodiment, each of the databases 23, 25, and 39, the data sources 31 and 35, and the computer(s)/computing system 51 can include a respective memory and a processor. For example, the computer(s)/computing system 51 can include a memory 51a and a processor 51b. According to an embodiment, the respective memories can be used to store computer instructions and data including any and all forms of non-volatile memory, including semiconductor devices (e.g., SRAM, DRAM, EPROM, EEPROM, and flash memory devices), magnetic disks (e.g., internal hard disks or removable disks), magneto-optical disks, and CD-ROM and DVD-ROM disks. Further, the respective processors can be suitable for the execution of a computer program and can include both general and special purpose microprocessors, as well as any one or more processors of any kind of digital computer. Further, the respective processors can receive instructions and data from the memories, e.g., to carry out at least part or all the processes.

Further, according to an embodiment, the components of the system 100 can be connected via a communications network. In this regard, the communications network 115 can include, or can interface to, at least one of the Internet, an intranet, a local area network (LAN), a wide area network (WAN), a metropolitan area network (MAN), a storage area network (SAN), a frame relay connection, an advanced intelligent network (AIN) connection, a synchronous optical network (SONET) connection, a digital T1, T3, E1 or E3 line, a digital data service (DDS) connection, a digital subscriber line (DSL) connection, an Ethernet connection, an integrated services digital network (ISDN) line, a dial-up port such as a V.90, a V.34 or a V.34bis analog modem connection, a cable modem, an asynchronous transfer mode (ATM) connection, a fiber distributed data interface (FDDI) connection, a copper distributed data interface (CDDI) connection, or an optical/DWDM network. In another embodiment, the communications network 115 can include, or can interface to, at least one of wireless application protocol (WAP) link, a Wi-Fi link, a microwave link, a general packet radio service (GPRS) link, a global system for mobile Communication (GSM) link, a Code Division Multiple Access (CDMA) link or a time division multiple access (TDMA) link such as a cellular phone channel, a GPS link, a cellular digital packet data (CDPD) link, a Research in Motion, Limited (RIM) duplex paging type device, a Bluetooth radio link, or an IEEE 802.11-based radio frequency link. Further, in another embodiment, the communications network 115 can include, or can interface to, at least one of an RS-232 serial connection, an IEEE-1394 (FireWire) connection, a Fibre Channel connection, an infrared (IrDA) port, a small computer systems interface (SCSI) connection, a universal serial bus (USB) connection or another wired or wireless, digital or analog interface or connection.

Further, according to an embodiment, each of the GUI 21 and the software modules 27 and 29 can be performed in one or more computer(s)/computing systems 51.

FIG. 2 depicts a block diagram of the system of FIG. 1 according to another exemplary embodiment of the invention. According to an embodiment, with the computer/computing system 51, a user can create an ideal virtual real estate space based on the available real estate and FFE. In this regard, the user can access available 3D floor plans 53 (which are retrieved from the database 23), selecting the one they find most suitable to their purposes. The user can then select the digital replicas 55 of various items of FEE they would like in the 3D real estate space, which are retrieved from the database 25. The 3D floor plans 53 can be from a number of data sources 31, e.g., real property developers developing property for sale, architects that have created plans for a house or other structure, landlords seeking renters, homeowners seeing to sell their home, etc. The various building unit or floor plans provided by the developer, architect, landlord, or homeowner can be rendered into interactive 3D floor plans 53 by the game engine software system 29, e.g., Unity game engine. The digital replicas 55 would be various FFE products provided by large corporations, small businesses, and other suppliers of such items. The digital replicas 55 can be generated using the computer-aided design software module 33, which is compatible with a Unity-based development platform. Further, the computing system 51 can track the costs of the FFE products/service by receiving such cost information from the data sources 35. According to an embodiment, after selection of the 3D floor plan 53 and the digital replicas 55, the computing system 51 can store, e.g., in its associated memory 51a, the respective name and/or unique identification number associated with the selected 3D floor plan 53 and the digital replicas 55. Further, the computing system 51 can also store datapoints representing the positioning information (e.g., x, y, z, and rotation) of the selected digital replicas 55 within the selected 3D floor plan 53. In this regard, the computing system 51 need not store the entire 3D files associated with the 3D floor plan 53 or the digital replicas 55. As such, the computing system 51 is able to save memory by only storing the positioning information of the 3D file and then rendering the 3D files with the positioning information. For example, after the selection of the 3D floor plan 53 and the digital replicas 55, the computing system 51 can (i) retrieve the 3D files from the respective databases, (ii) determine if the retrieved 3D files include names and/or unique identification numbers that match names and/or unique identification numbers stored in the computing system 51, (iii) upon determining that the names and/or unique identification numbers associated with the retrieved 3D files match names stored in the computing system 51, retrieve positioning information for the matched 3D files, (iv) render the 3D real estate space based on the retrieved 3D files and the retrieved positioning information.

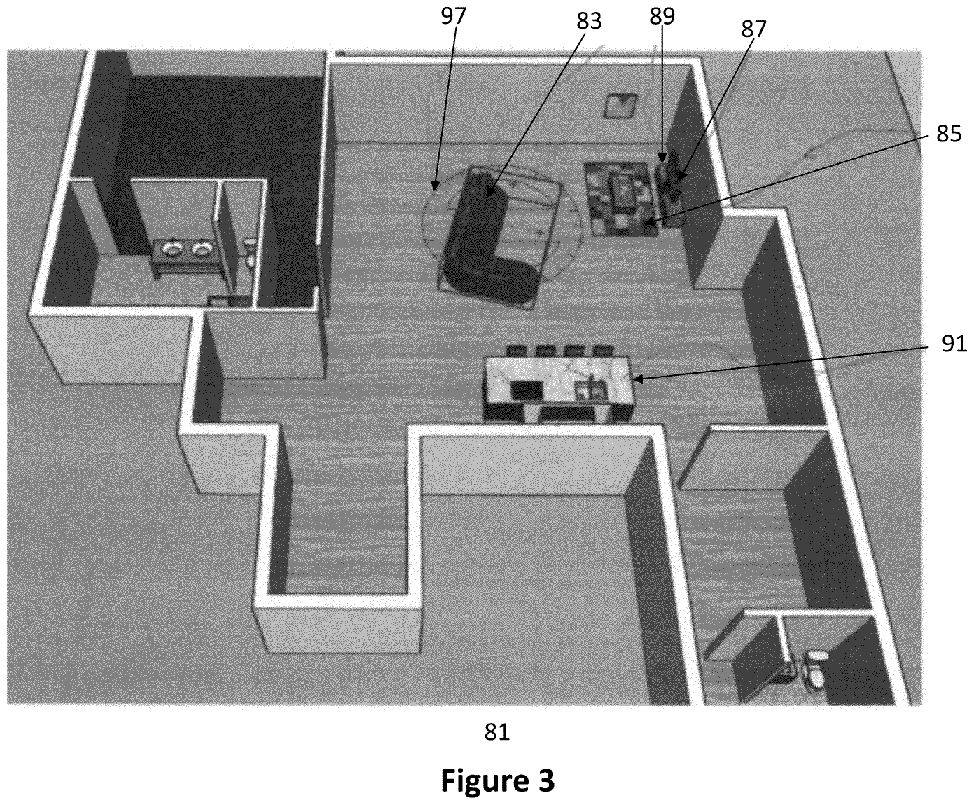

FIG. 3 depicts a screenshot of a graphical user interface according to an exemplary embodiment of the invention. In particular, the figure depicts an interactive 3D virtual real estate space 81 that a user of the system 100 has selected and is in the process of manipulating. Various digital replicas of furniture and other items have been placed in the interactive 3D virtual real estate space 81, such as a couch 83, a rug 85, a television 87 on a TV stand 89, and a table 91. Additionally, various fixtures are also in the interactive 3D virtual real estate space 81 such as a dual sink vanity 93 and a toilet 95, among other items. Further, as indicated by the circular protractor sign 97 the customer is in the process of manipulating the position of the couch to determine how it appears in the interactive 3D virtual real estate space 81. In this regard, the user of the system 100 can go through the process of selecting and trying various digital replicas to achieve the desired living space.

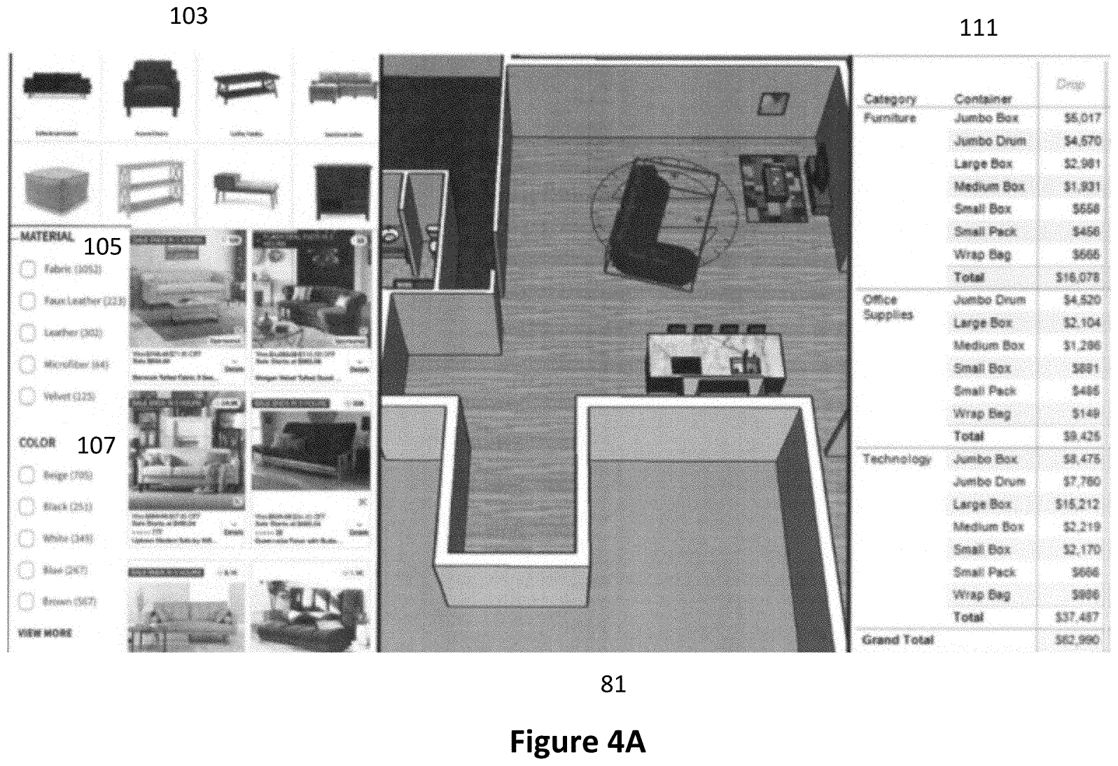

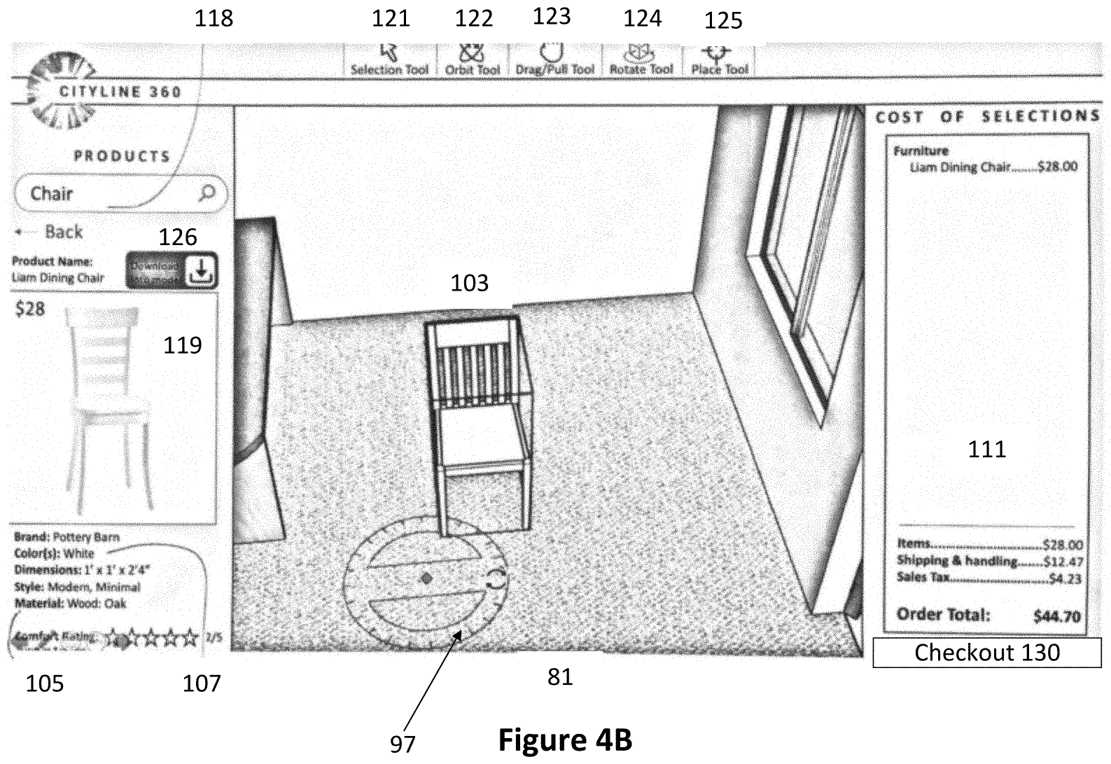

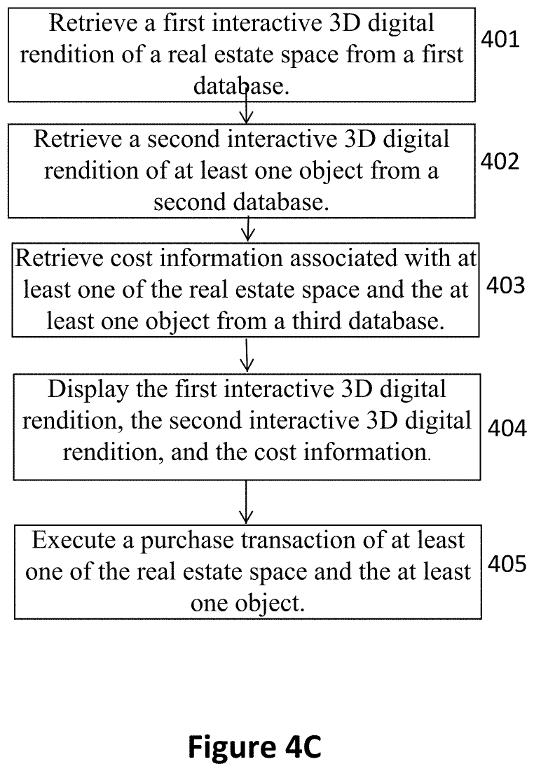

FIG. 4A depicts a screenshot of the graphical user interface in FIG. 3 according to another exemplary embodiment of the invention. For example, the figure depicts the interactive 3D virtual real estate space 81 as well as a plurality of selected digital replicas 103, which can be selected based on appearance, material 105, color 107, and other features (e.g., brand, color, dimensions, style, rating, etc.). Further, the figure also depicts a running tally 111 of the cost associated with the selected digital replicas 103. For example, the figure depicts a running tally 111 of the costs based on the categories: furniture, office supplies, and technology. Further, the running tally 111 also includes the grand total of costs associated with the interactive 3D virtual real estate space 81.

FIG. 4B depicts a screenshot of the graphical user interface in FIG. 3 according to another exemplary embodiment of the invention. For example, the figure depicts a search bar 118 to search for and select a desired FFE, e.g., a chair, a display area 119 to display the selected chair and its features (e.g., brand, color, dimensions, style, material, and comfort rating), the digital replica 103 of the selected chair, as well as the running tally 111 of the cost associated with the selected chair. Further, the GUI 21 also includes a selection tool 121 for selecting objects within the interactive 3D virtual real estate space 81, an orbit tool 122 to selectively orbit the view of the interactive 3D virtual real estate space 81, a drag/pull tool 123 to selectively drag/pull the view of the interactive 3D virtual real estate space 81, a rotate tool 124 to selectively rotate the view of the digital replica 103 in the interactive 3D virtual real estate space 81, and a placing tool 125 to selectively place the digital replicas 103 in the interactive 3D virtual real estate space 81. Further, as depicted in the figure, the GUI 21 also includes a download button 126 to download the digital replica 103 of the desired FFE.

Further, according to an embodiment, after the user is satisfied with the interactive 3D virtual real estate space 81 and digital replicas 103, the user can electronically purchase the real-life versions of the interactive 3D virtual real estate space 81 and digital replicas 103 using the checkout button 130. In this regard, the GUI 21 can also be used to arrange times for when the user can acquire access to the property from the landlord or previous owner. The GUI 21 can consider additional costs such as tax, security deposits, and furnishing costs (based on furnishing selections of the user, among other costs). Further, according to another embodiment, the GUI 21 can also act as a record for the legal change of title of properties. Further, inputs can be available to take in the user's credit card and/or bank account information for the execution of a purchase transaction.

FIG. 4C depicts a method according to an exemplary embodiment of the invention. As depicted in the figure, in step 401, upon a selection of the real estate space with a GUI (e.g., GUI 21), a first interactive 3D digital rendition of the real estate space (e.g., 3D floor plan 53, 3D virtual real estate space 81, etc.) is retrieved from a first database (e.g., database 23). Then, in step 402, upon a selection of the at least one object with the GUI, a second interactive 3D digital rendition of the at least one object (e.g., digital replicas 55, 103, etc.) is retrieved from a second database (e.g., database 25). Then, in step 403, upon a selection of at least one of real estate space and the at least one object with the GUI, cost information associated with at least one of the real estate space and the at least one object is retrieved from a third database (e.g., database 39). Then, in step 404, the GUI displays the first interactive 3D digital rendition of the real estate space, the second interactive 3D digital rendition of the at least one object, and the cost information associated with the at least one of the real estate space and the at least one object. Then, in step 405, the GUI executes a purchase transaction of the at least one real estate space and the at least one object.

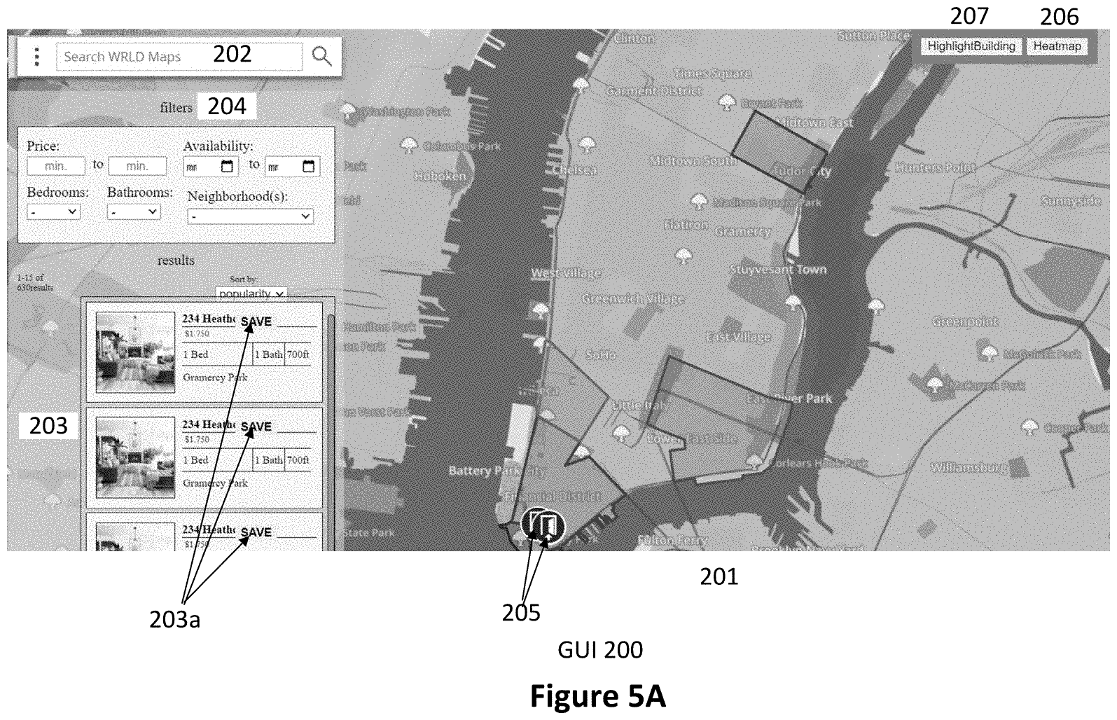

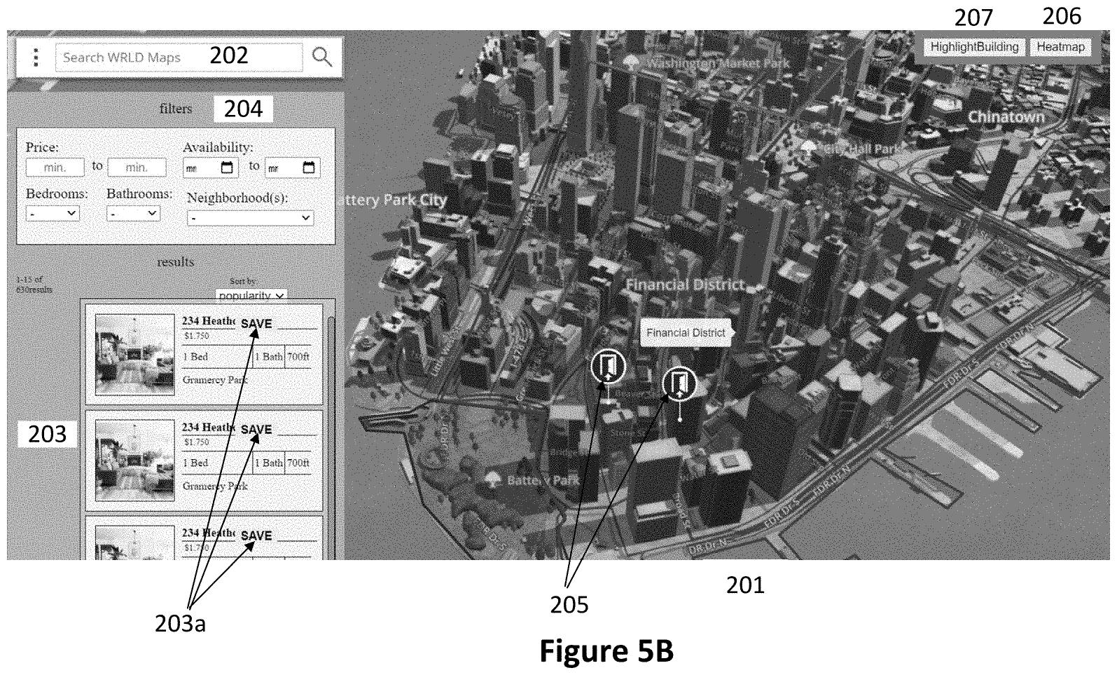

FIG. 5A depicts a screenshot of a graphical user interface according to an exemplary embodiment of the invention. In particular, the figure depicts a geographic GUI 200. According to an embodiment, the GUI 200 can be implemented with the game engine software system 29. Further, as depicted in the figure, the GUI 200 can include an interactive map display 201, a search bar 202 for location-based searches, a search results list 203 of real estate listings (with corresponding selectable buttons in the interactive map display 201), and a filter tool 204 to filter through the search results list 203.

According to an embodiment, the GUI 200 allows a user to move freely through the interactive map display 201. For example, a user can pan the interactive map display 201 in order to look at un-displayed portions of the interactive map display 201. Further, the user can pan over and orbit around the buildings in the interactive map display 201. Further, a user can zoom into or out of certain portions of the interactive map display 201, thereby revealing certain 3D building structures in the interactive map display 201 as depicted in FIG. 5B. Further, the user can also use a “street view” feature that will allow the user to view the buildings at the street level. In this regard, any of the above movements within the interactive map display 201 can reorder the search results list 203 in order to prioritize the listings that are currently visible to the user on the interactive map display 201. In another embodiment, the interactive map display 201 can also include a “driving view” feature that will allow the user to view the buildings as if they were driving at the street level. In another embodiment, the interactive map display 201 can also include a “flight simulator” feature that will allow the user to view the buildings as if they were flying in an airplane.

Further, according to an embodiment, with the search bar 202, a user can search for and be directed to locations based on addresses, street names, neighborhood names, zip codes, building names, etc. Further, according to an embodiment, the search results list 203 can include photos of the listing as well as listing information regarding address, unit, number of beds, number of baths, square footage, and price, among other datapoints. Further, as described above, each listing will be linked to its positioning on the interactive map display 201, and a corresponding button 205 will appear on the interactive map display 201 that is linked to the listing. Further, the GUI 200 also provides the user the ability to save one or more of the listings in the search results list 203, e.g., by clicking a save button 203a associated each of the listings. Further, the listings in the search result list 203 can also be sorted, e.g., by popularity, etc.

Further, according to an embodiment, the filter tool 204 allows the user to narrow down the search result list 203 based on datapoints including (but not limited to) price (minimum and maximum), number of beds, number of baths, availability (e.g., move-in date), move-out date, and neighborhood. Further, according to an embodiment, the GUI 200 can also include a data visualization tool. In this regard, the data visualization tool can allow the user to see location-based information for each building including (but not limited to) average price per available unit, average size per available unit, building height, building age, building neighborhood, etc. Further, the data visualization tool can also include a color key, with each color corresponding to a different datapoint. According to an embodiment, the building can change colors in order to represent a datapoint that will be visible on the above-mentioned color key. Further, the data visualization tool can be used to delineate different neighborhoods in a map, e.g., Financial District, Battery Park City, etc. In this regard, each neighborhood can be highlighted with a different color. Further, the data visualization tool can also provide heat map overlays 206 (e.g., to depict the heat map for a desired area in the interactive map display 201) as well as the ability to highlight specific buildings 207 (e.g., to distinguish them from surrounding buildings).

Further, according to an embodiment, after the user discovers a listing that they might be interested in, the user is then able to (i) select a listing from the search result list 203 or the interactive map display 201 and (ii) virtually “enter” into the property associated with the listing, e.g., apartment, condo, office, etc. According to an embodiment, after a listing is selected, certain listing information can appear over the interactive map display 201. The listing information can include (but is not limited to) datapoints such as unit and address, listing photos, property descriptions, amenities, number of bedrooms, number of bathrooms, etc. Further, the listing information can also include a button that allows the user to virtually “enter” into the property associated with the listing.

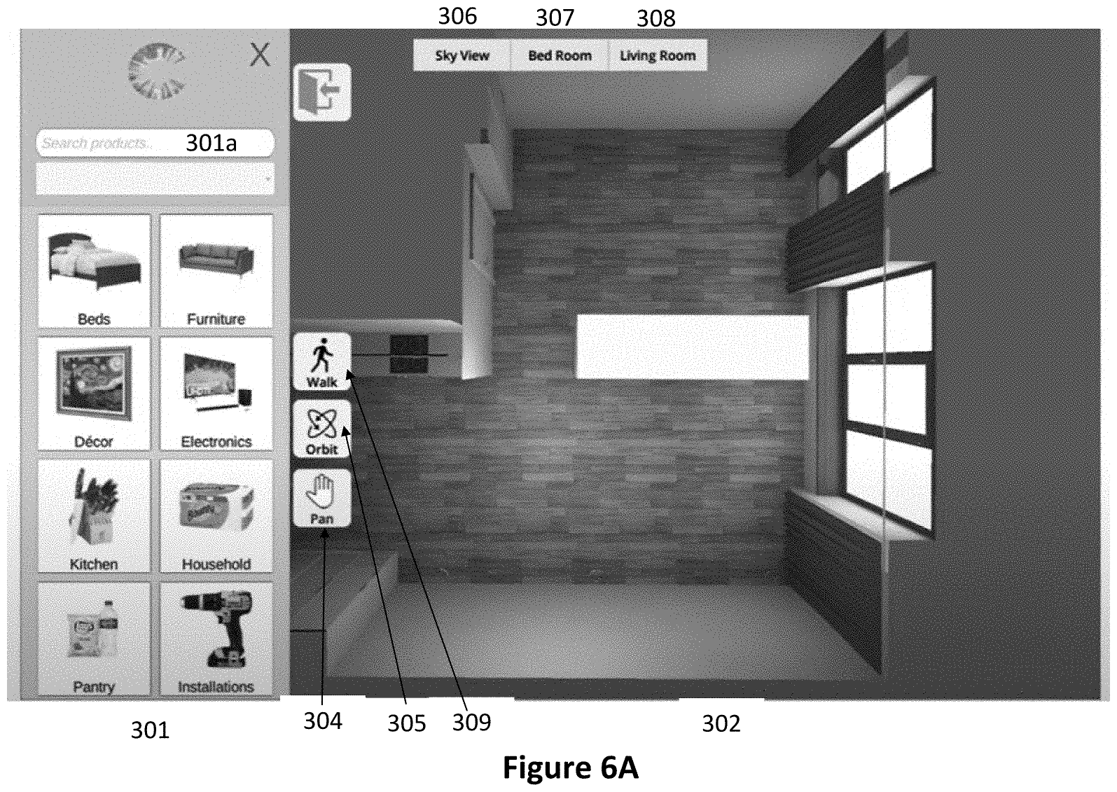

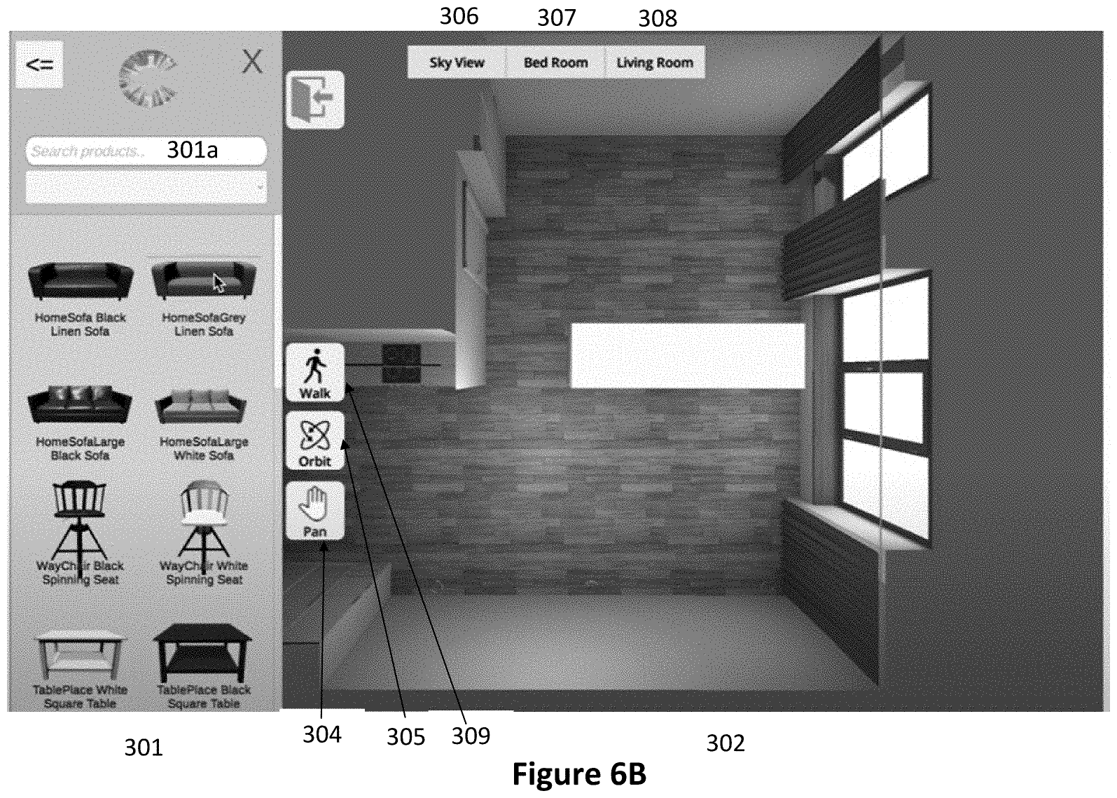

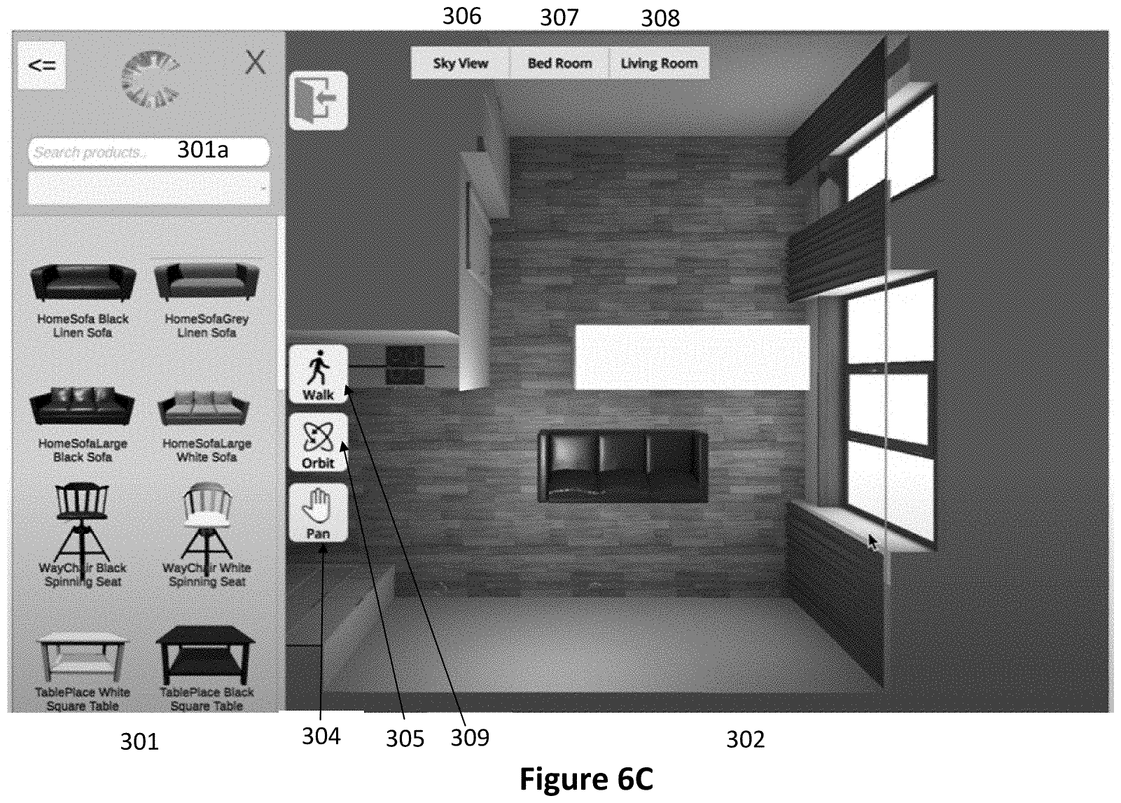

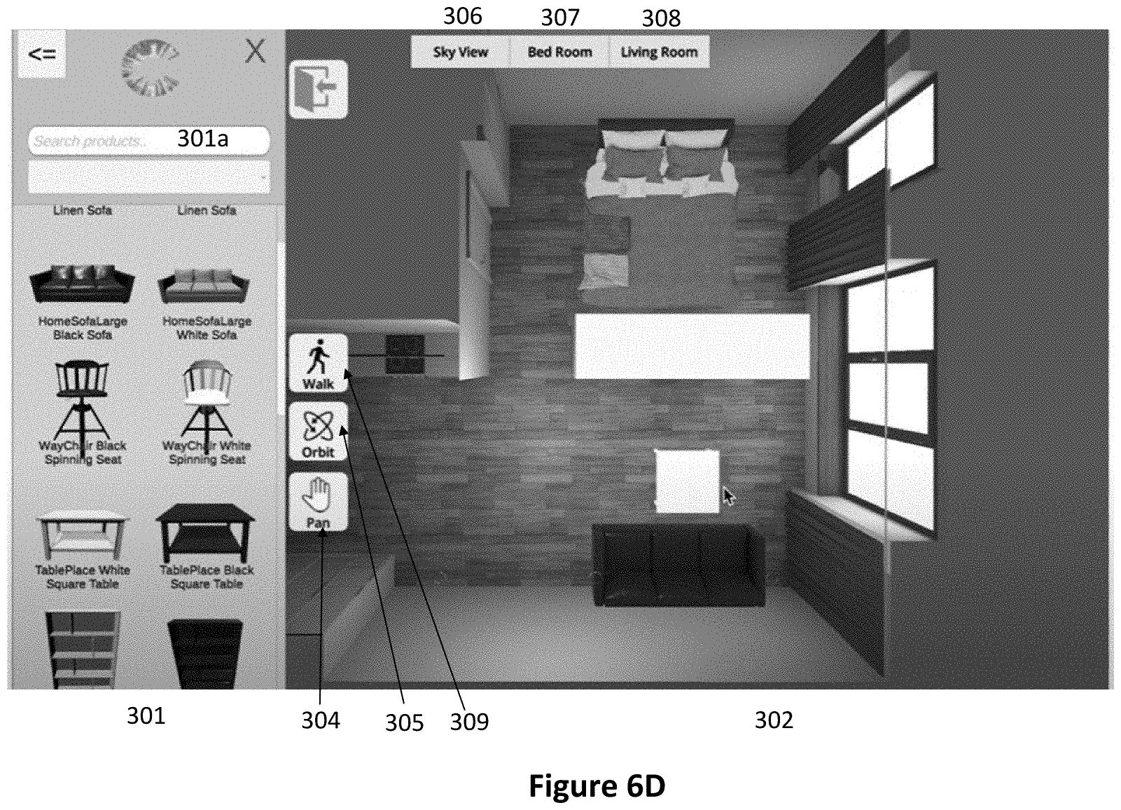

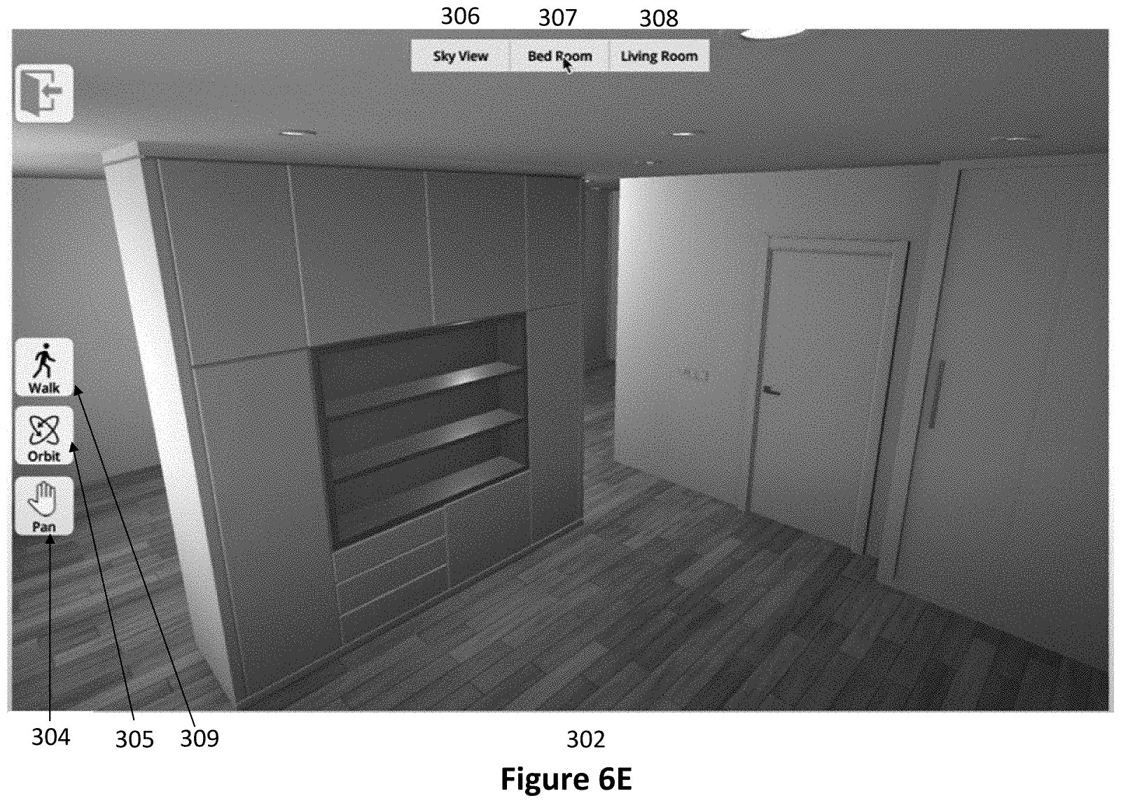

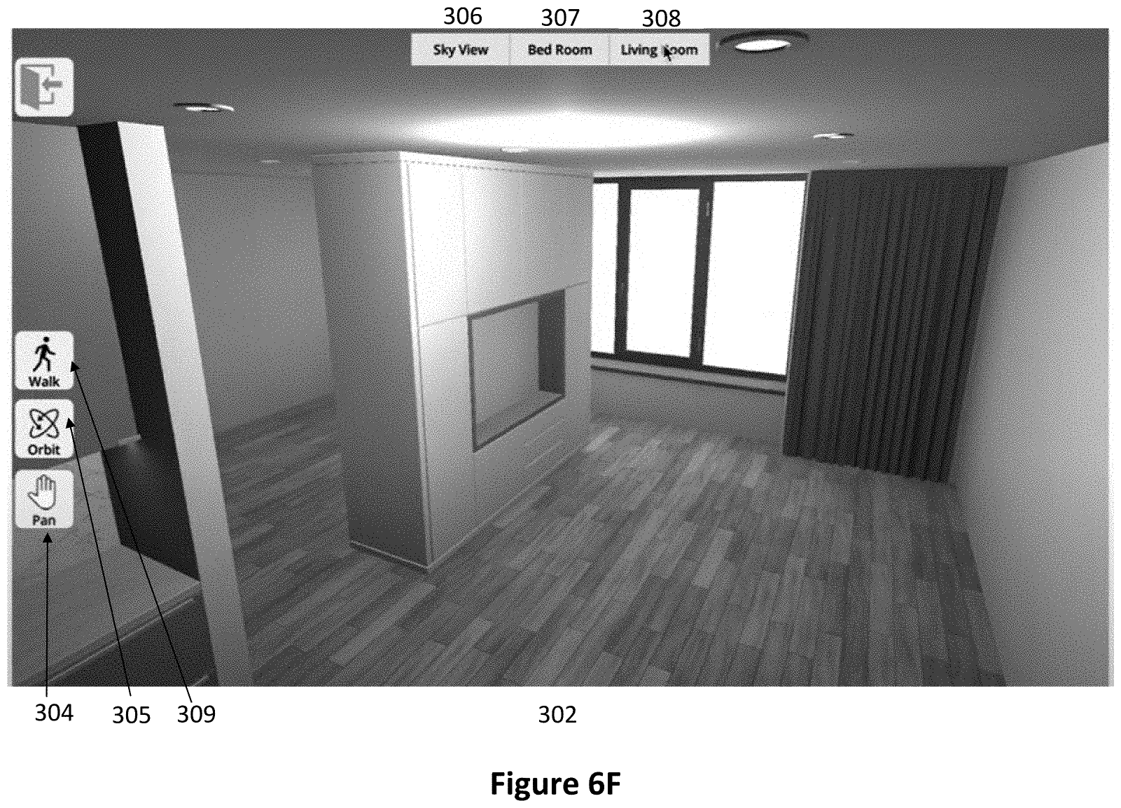

In this regard, after the user virtually “enters” the property, the user is transitioned to a point of sale (POS) GUI 300, as depicted in FIG. 6A. According to an embodiment, the GUI 300 can be implemented with the game engine software system 29. Further, the GUI 300 can include the following components: (i) a product marketplace 301, (ii) an interactive 3D virtual real estate space 302, and a subtotal calculator 303. With regard to the product marketplace 301, a dynamic, real-time backed-end database of products, e.g., the database 25, can be used to store and maintain products that can be associated with the listing. As described above and depicted in FIGS. 6A and 6B, the items comprising such a database can include (but are not limited to) furniture, décor, contracted services (such as flooring or paint installations), electronics, and home essentials (such as pantry items, toilet paper, and paper towels). Further, the back-end database can store datapoints related to the above products including (but not limited to) a 3D file of the product, as well as photos, price, color, size, material, style, weight, inventory, and brief descriptions of the product. According to an embodiment, the products in the product marketplace 301 can be searched for using a search 301a. Further, the above-described datapoints can be used by the user to narrow down/filter the products displayed in the product marketplace 301. Further, price-per-square-foot products, such as flooring or wall paint, can be based on a selection of either floor areas and/or wall areas in the interactive 3D virtual real estate space 302. In this regard, the area of selection will indicate, for example, (i) how many buckets of paint are recommended for purchase and/or (ii) how much flooring is required. Further, according to an embodiment, a location of the user within the interactive 3D virtual real estate space 302 can be used to rearrange the products in the product marketplace 301. For example, if the user is decorating a bathroom, then kitchen and living room furniture will not be prioritized within the marketplace, while toiletries and towels might be.

Further, once a product that the user wants to embed into the interactive 3D virtual real estate space 302 is found, the user can import the 3D file associated with the product by (i) dragging in the photograph associated with the product into the interactive 3D virtual real estate space 302, (ii) clicking an import button, or (iii) using an alternative method. For example, as depicted in FIGS. 6C and 6D, 3D files associated with a couch, table, and bed have been imported into the interactive 3D virtual real estate space 302.

According to an embodiment, the interactive 3D virtual real estate space 302 can include the following components: (i) user movement (and related sounds), (ii) product/object movement (and related sounds), (iii) a shared game environment feature, (iv) physics-based lighting, (v) space-related calculations, and (vi) shareability/publishing feature.

In this regard, the user movement can include one of free movement, assisted movement, custom movement, and first-person movement. According to an embodiment, the free movement feature allows the user to move freely through the 3D virtual real estate space 302 using the zoom, pan, and orbit functions. In this regard, the pan function can be implemented by enabling the pan button 304, the orbit function can be implemented by enabling the orbit button 305, and the zoom function can be implemented using a scroll command on a mouse and/or a tap command on the track pad. Further, the assisted movement feature allows the users to select existing “set view” buttons that can automatically set the view to the selected location, e.g., sky view button 306 (e.g., view the interactive 3D virtual real estate space 302 from above), bed room button 307 (e.g., view the interactive 3D virtual real estate space 302 from the location designated as the bed room), and living room button 308 (e.g., view the interactive 3D virtual real estate space 302 from the location designated as the living room). For example, FIGS. 6A to 6D correspond to the sky view, while FIG. 6E corresponds to the bedroom view and FIG. 6F corresponds to the living room view. Further, the custom movement feature provides the user the ability to add their own set views and name said views before saving them. The saved views can be represented by a camera location on the x, y, and z axes and a camera rotation on the x, y, and z axes. Further, according to an embodiment, the user can have the ability to change key stroke commands to better fit their preferences. Further, with the first-person movement feature, users can have the ability to virtually move around the 3D virtual real estate space 302 from the perspective a person touring the space (either before or after furnishing it) e.g., by selecting the “walk” button 309. According to an embodiment, the first-person movement will fluctuate minimally and steadily along the y axis to mimic the feeling of walking. In addition, the first-person movement can also include sounds that mimic the sounds of human footsteps.

With regard to object movement, objects, e.g., digital replicas, will be placeable in only realistic positions, e.g., furniture on the floor, paintings on the wall, and no interceptions between two individual objects or individual object and a floor or wall boundary. Further, according to an embodiment, the objects can be moved, rotated, and removed, but cannot be manipulated with respect to size and shape. Further, audio/sound aids can be used to indicate specific movements as well as correct and/or incorrect object placement.

With regard to shared game environment, users can create a shared game environment that gives other approved users access to the shared game environment. As such, multiple users can manipulate the same 3D virtual real estate space 302 at the same time. According to an embodiment, a user can invite one or more other users to read and write onto the same 3D virtual space 302. In this regard, if another user accepts the invitation, the computing system 51 can retrieve and track IP addresses associated with digital replicas being added to the 3D virtual real estate space 302 by the other users. Further, according to an embodiment, the computing system 51 can store, e.g., in its associated memory 51a, the respective name and/or unique identification number associated with the digital replicas 55 being added by the other users. Further, the computing system 51 can also store datapoints representing the positioning information (e.g., x, y, z, and rotation) of the digital replicas 55 being added by the other users. Further, according to an embodiment, the shared 3D virtual real estate space 302 can be refreshed/updated based upon a user's call (e.g., by either using a button or reloading the URL) or upon program update (e.g., once every few seconds). Further, when a user proceeds to a checkout URL, edits to the shared 3D virtual real estate space 302 can be temporarily suspended. According to an embodiment, a bill can be split between the user and the other users based on IP addresses associated with digital replicas being added to the 3D virtual real estate space 302. In this regard, inputs can be available to take in the user's and/or other users credit card and/or bank account information for the execution of a purchase transaction.

With regard to physics-based lighting, the 3D virtual real estate space 302 can make use of light features provided by physics-based game engines including (but not limited to) directional lights, point lights, spotlights, area lights, reflection probes, and light probe groups.

With regard to space-related calculations, when selecting a price-per-square-foot product, the user is able to use an area calculating tool that calculates the price of filling the area with the selected price-per-square-foot product, e.g., paint, flooring, etc. Further, according to an embodiment, based on the size of doorways within the listing space and the size of items dragged into the listing space, the GUI 300 can notify the buyer if an object is too large to fit in a room or the smallest point of egress through the building.

With regard to ability/publishing feature, users can share their furnished 3D virtual real estate spaces 302 to social media and/or to a publishing page of a website. In this regard, users can search the publishing page by categories including (but not limited to) total furnishing cost, professional interior designer furnishings, or style of furnishing.

Further, according to an embodiment, the subtotal calculator 303 allows the users to see the running total of the furnishings as well as the costs of closing on the real estate transaction associated with the 3D virtual real estate space 302. Further, the subtotal calculator can be organized by different categories including (but not limited to) the room it is in and the item type of the object.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A point of sale system for virtually visualizing a real estate space and at least one object to be used within the real estate space, the system comprising:
a first database including a first interactive three-dimensional (3D) digital rendition of the real estate space, wherein the first interactive 3D rendition is based on at least a first file associated with one or more structures in the real estate space and at least a second file associated with one or more textures in the real estate space;
a second database including a second interactive 3D digital rendition of the at least one object;
a third database including cost information associated with at least one of the real estate space and the at least one object; and
a computer-implemented graphical user interface (GUI), wherein the computer-implemented GUI is configured to:
retrieve, in real time, the first interactive 3D digital rendition of the real estate space from the first database upon a selection of the real estate space with the GUI;
retrieve, in real time, the second interactive 3D digital rendition of the at least one object from the second database upon a selection of the at least one object with the GUI;
retrieve, in real time, the cost information from the third database upon the selection of at least one of the real estate space and the at least one object with the GUI; and
display the first interactive 3D digital rendition of the real estate space, the second interactive 3D digital rendition of the at least one object, and the cost information associated with the at least one of the real estate space and the at least one object, wherein the second interactive 3D digital rendition of the at least one object is movable within the first interactive 3D digital rendition of the real estate space.

2. The system of claim 1, further comprising:
a first data source including a two-dimensional (2D) digital rendition of the real estate space; and
a second data source including a digital rendition of the at least one object.

3. The system of claim 2, further comprising:
a game engine software system, wherein the game engine software system is configured to generate the first interactive three-dimensional (3D) digital rendition of the real estate space based on the 2D digital rendition of the real estate space.

4. The system of claim 2, further comprising:
a computer-aided design software module, wherein the computer-aided design software module is configured to generate the second interactive 3D digital rendition of the at least one object based on the digital rendition of the at least one object.

5. The system of claim 1, wherein the real estate space corresponds to one of an apartment, a condominium, a house, a factory, a commercial space, and an office space.

6. The system of claim 1, wherein the at least one object corresponds to at least one of furniture, fixtures, and equipment.

7. The system of claim 1, wherein the first interactive 3D digital rendition is associated with a .jpg file format and a .obj file format, and wherein the second interactive 3D digital rendition is associated with at least one of the .obj file format, the .jpg file format, a .fdx file format, and a .stl file format.

8. The system of claim 1, further comprising:
a geographic GUI, wherein the geographic GUI comprises:
an interactive map display, wherein the interactive map display includes a 3D representation of real physical locations of a plurality of buildings associated with real estate spaces;
a search bar, wherein the search bar is configured to search for real estate spaces in the interactive map display; and
a search results list, wherein the search results list displays a list of results from the search performed with the search bar, wherein each of the results is linked to a corresponding position in the interactive map display.

9. The system of claim 8, wherein the geographic GUI is configured to display another GUI upon a user selection of one of the results, wherein the one of the results can be selected in at least one of the search results list and the interactive map display.

10. The system of claim 1, wherein the second interactive 3D digital renditions of one or more objects can be associated with distinct users, wherein the first interactive 3D rendition is configured to be manipulated by the distinct users at a same time.

11. The system of claim 10, wherein the distinct users can be tracked based on Internet Protocol (IP) addresses associated with the one or more objects.

12. The system of claim 1, wherein the computer-implemented GUI is configured to execute a purchase transaction of at least one of the real estate space and the at least one object upon a user selection of the at least one of the real estate space and the at least one object for purchase.

13. A point of sale method for virtually visualizing a real estate space and at least one object to be used within the real estate space, the method comprising:
upon a selection of the real estate space with a computer-implemented graphical user interface (GUI), retrieving, with the computer-implemented GUI, in real time, a first interactive three-dimensional (3D) digital rendition of the real estate space from a first database, wherein the first interactive 3D rendition is based on at least a first file associated with one or more structures in the real estate space and at least a second file associated with one or more textures in the real estate space;
upon a selection of the at least one object with the computer-implemented GUI, retrieving, with the computer-implemented GUI, in real time, a second interactive 3D digital rendition of the at least one object from a second database;
upon a selection of at least one of real estate space and the at least one object with the computer-implemented GUI, retrieving, with the computer-implemented GUI, in real time, cost information associated with at least one of the real estate space and the at least one object from a third database; and
displaying, with the computer-implemented GUI, the first interactive 3D digital rendition of the real estate space, the second interactive 3D digital rendition of the at least one object, and the cost information associated with the at least one of the real estate space and the at least one object, wherein the second interactive 3D digital rendition of the at least one object is movable within the first interactive 3D digital rendition of the real estate space.

14. The method of claim 13, further comprising:
generating, with a game engine software system, the first interactive 3D digital rendition of the real estate space based on a two-dimensional (2D) digital rendition of the real estate space.

15. The method of claim 13, further comprising:
generating, with a computer-aided design software module, the second interactive 3D digital rendition of the at least one object based on a digital rendition of the at least one object.

16. The method of claim 13, wherein the real estate space corresponds to one of an apartment, a condominium, a house, a factory, a commercial space, and an office space.

17. The method of claim 13, wherein the at least one object corresponds to at least one of furniture, fixtures, and equipment.

18. The method of claim 13, wherein the first interactive 3D digital rendition is associated with a .jpg file format and a .obj file format, and wherein the second interactive 3D digital rendition is associated with at least one of the .obj file format, the .jpg file format, a .fdx file format, and a .stl file format.

19. The method of claim 13, further comprising:
executing, with the computer-implemented GUI, a purchase transaction of at least one of the real estate space and the at least one object.
